(19) United States
(12) Patent Application Publication
(10) Pub. No.: US 2019/0300256 A1
(43) Pub. Date: Oct. 3, 2019

(54) CARTON AND BLANK THEREFOR

(71) Applicant: WestRock Packaging Systems, LLC, Atlanta, GA (US)

(72) Inventor: Caleb S. Loftin, Richmond, VA (US)

(21) Appl. No.: 16/302,319

(22) PCT Filed: May 26, 2018
(86) PCT No.: PCT/US2017/034646

§ 371 Date: Nov. 16, 2018

Related U.S. Application Data
(60) Provisional application No. 62/344,029, filed on Jun. 1, 2016.

(51) Int. Cl. B65D 71/36; B31B 50/26

(52) U.S. Cl. CPC B65D 71/36; B31B 50/26; B65D 2571/00141; B31B 50/624; B65D 2571/0066; B65D 2571/00728; B65D 2571/00444

(57) ABSTRACT

A carton includes a tubular structure having a plurality of outer walls defining an interior volume for receiving one or more articles. The carton includes a major end closure flap hinged to a first outer wall and a minor end closure flap hinged to a second outer wall. The minor end closure flap at least partially overlies the major end closure flap. The carton has an automatically erecting article-retaining structure hingedly connected to the major and minor end closure flaps.

### TECHNICAL FIELD

The present invention relates to cartons and to blanks for forming the same. More specifically, but not exclusively, the invention relates to a carton having a cushioning structure for constraining articles within an interior volume of the carton.

### BACKGROUND

In the field of packaging it is known to provide cartons for carrying multiple articles. Cartons are well known in the art and are useful for enabling consumers to transport, store and access a group of articles for consumption. For cost and environmental considerations, such cartons or carriers need to be formed from as little material as possible and cause as little wastage in the materials from which they are formed as possible. Further considerations are the strength of the carton and its suitability for holding and transporting large weights of articles. It is desirable that the contents of the carton are secure within the carton, and that the carton is a close or tight fit about the contents, so as to prevent or inhibit movement of the contents within the carton.

The present invention seeks to provide an improvement in the field of cartons, typically formed from paperboard or the like.

### SUMMARY

According to a first aspect of the present disclosure there is provided a carton for packaging one or more articles. The carton comprises a tubular structure having a plurality of outer walls defining an interior volume for receiving one or more articles. The plurality of outer walls includes first and second outer walls and a plurality of end closure flaps for at least partially closing an open end of the tubular structure. The plurality of end closure flaps includes first major and first minor end closure flaps, wherein the first major end closure flap is hinged to the first outer wall so as to be hingedly movable between an opened position, where the first major end closure flap lies generally in a plane of the first outer wall, and a closed position where the first major end closure flap at least partially closes the open end. The first minor end closure flap is hinged to the second outer wall so as to be hingedly movable between an opened position, where the first minor end closure flap lies generally in a plane of the second outer wall, and a closed position, where the first minor end closure flap at least partially closes the open end, the second outer wall being disposed adjacent to the first outer wall. The first minor end closure flap is coupled to the first major end closure flap such that the first minor end closure flap moves from the opened position thereof towards the closed position thereof in response to movement of the first major end closure flap from the opened position thereof to the closed position thereof. The first minor end closure flap at least partially overlies the first major end closure flap when the first major end closure flap is in the closed position thereof. The first major end closure flap is greater in a length dimension than the first minor end closure flap. The length dimension of the first major and first minor end closure flaps may be defined by the maximum distance between a free end of a respective one of the first major and first minor end closure flaps and a hinged connection between said respective one of the first major and first minor end closure flaps and the respective one of the plurality of outer walls to which said respective one of the first major and first minor end closure flaps is hinged, such that a portion of the first major end closure flap extends proud of the first minor end closure flap when the first major and the first minor end closure flap are each in the opened position.

Optionally, the plurality of outer walls further includes a third outer wall, wherein the plurality of end closure flaps further includes a second major end closure flap hinged to the third outer wall so as to be hingedly movable between an opened position, where the second major end closure flap lies generally in a plane of the third outer wall, and a closed position where the second major end closure flap at least partially closes the open end. The third outer wall may be disposed adjacent to the second outer wall, the second major end closure flap overlying the first major and first minor end closure flaps when the first major, first minor and second major end closure flaps are in the closed positions respectively, such that the first minor end closure flap is disposed between the first and second major end closure flaps.

Optionally, the plurality of outer walls further includes a fourth outer wall, wherein the plurality of end closure flaps further includes a second minor end closure flap hinged to the fourth outer wall so as to be hingedly movable between an opened position, where the second minor end closure flap lies generally in a plane of the fourth outer wall, and a closed position where the second minor end closure flap at least partially closes the open end. The fourth outer wall may be disposed adjacent to the first and third outer walls. The second minor end closure flap is coupled to the first major end closure flap such that the second minor end closure flap moves from the opened position thereof toward the closed position thereof in response to movement of the first major end closure flap from the opened position thereof to the closed position thereof. The second minor end closure flap at least partially overlies the first major end closure flap when the first major end closure flap is in the closed position thereof and wherein the second major end closure flap overlies the second minor end closure flap when the second major and second minor end closure flaps are in the closed positions respectively, such that the second minor end closure flap is disposed between the first and second major end closure flaps.

Optionally, the first major end closure flap comprises a first portion proximate a hinged connection between the first major end closure flap and the first outer wall and a second portion distal from the hinged connection. The first portion comprises a first width dimension and the second portion comprises a second width dimension. The first width dimension may be substantially equal to a width dimension of the first outer wall, and the second width dimension is less than the width dimension of the first outer wall.

Optionally, the first minor end closure flap is coupled to the first major end closure flap by a first web panel.

Optionally, the second minor end closure flap is coupled to the first major end closure flap by a second web panel.

Optionally, a first web panel is hingedly connected to the first minor end closure flap and is hingedly connected to a first portion of the first major end closure flap, the first portion being proximate a hinged connection between the first major end closure flap and the first outer wall.

Optionally, the second web panel is hingedly connected to the second minor end closure flap and is hingedly connected to a first portion of the first major end closure flap, the first portion being proximate a hinged connection between the first major end closure flap and the first outer wall.

Optionally, the first minor end closure flap comprises a first cutaway defining a chamfered edge thereof. The first cutaway is provided at a first end of the first minor end closure flap, the first end opposing a second end of the first minor end closure flap to which the first web panel is hinged.

Optionally, the second minor end closure flap comprises a second cutaway defining a chamfered edge thereof. The second cutaway is provided at a first end of the second minor end closure flap, the first end opposing a second end of the second minor end closure flap to which the second web panel is hinged.

According to a second aspect of the present disclosure there is provided a blank for forming a carton. The blank comprises a plurality of panels for providing outer walls of a tubular structure, the plurality of panels including first and second panels, and a plurality of end closure flaps for at least partially closing an open end of the tubular structure. The plurality of end closure flaps includes first major and first minor end closure flaps. The first major end closure flap is hinged to the first panel such that when the tubular structure is set up, the first major end closure flap is hingedly movable between an opened position, where the first major end closure flap lies generally in a plane of the first panel, and a closed position where the first major end closure flap at least partially closes the open end. The first minor end closure flap is hinged to the second panel such that when the tubular structure is set up, the first minor end closure flap is hingedly movable between an opened position, where the first minor end closure flap lies generally in a plane of the second panel, and a closed position where the first minor end closure flap at least partially closes the open end, the second panel being disposed adjacent to the first panel. The first minor end closure flap is coupled to the first major end closure flap such that the first minor end closure flap moves from the opened position thereof toward the closed position thereof in response to movement of the first major end closure flap from the opened position thereof to the closed position thereof. The first minor end closure flap at least partially overlies the first major end closure flap when the first major end closure flap is in the closed position. The first major end closure flap comprises a first length dimension, the first length dimension being defined by the maximum distance between a free end of the first major end closure flap and a hinged connection between the first major end closure flap and the first panel and wherein the first minor end closure flap comprises a second length dimension. The second length dimension may be defined by the maximum distance between a free end of the first minor end closure flap and a hinged connection between the first minor end closure flap and the second panel, the first length dimension being greater than the second length dimension such that a portion of the first major end closure flap extends proud from the first minor end closure flap.

According to a third aspect of the present disclosure there is provided a method of forming a carton. The carton comprises a tubular structure having a plurality of outer walls defining an interior volume for receiving one or more articles. The plurality of outer walls includes first and second outer walls, and a plurality of end closure flaps for at least partially closing an open end of the tubular structure, the plurality of end closure flaps including first major and first minor end closure flaps. The first major end closure flap is hinged to the first outer wall so as to be hingedly movable between an opened position, where the first major end closure flap lies generally in a plane of the first outer wall, and a closed position where the first major end closure flap at least partially closes the open end. The first minor end closure flap is hinged to the second outer wall so as to be hingedly movable between an opened position, where the first minor end closure flap lies generally in a plane of the second outer wall, and a closed position where the first minor end closure flap at least partially closes the open end, the second outer wall being disposed adjacent to the first outer wall. The first minor end closure flap is coupled to the first major end closure flap. The first major end closure flap comprises a first length dimension, the first length dimension being defined by the maximum distance between a free end of the first major end closure flap and a hinged connection between the first major end closure flap and the first panel and wherein the first minor end closure flap comprises a second length dimension. The second length dimension may be defined by the maximum distance between a free end of the first minor end closure flap and a hinged connection between the first minor end closure flap and the second panel. The first length dimension may be greater than the second length dimension such that a portion of the first major end closure flap extends proud from the first minor end closure flap. The method comprises the steps of: engaging the portion of the first major end closure flap that extends proud from the first minor end closure flap; moving the first major end closure flap from the opened position thereof toward the closed position thereof; automatically moving the first minor end closure flap from the opened position thereof toward the closed position thereof in response to the moving step of the first major end closure flap such that the first minor end closure flap at least partially overlies the first major end closure flap when the first major end closure flap is moved to the closed position thereof.

Optionally, the plurality of outer walls further includes a third outer wall, wherein the plurality of end closure flaps further includes a second major end closure flap hinged to the third outer wall so as to be hingedly movable between an opened position, where the second major end closure flap lies generally in a plane of the third outer wall, and a closed position where the second major end closure flap at least partially closes the open end. The third outer wall may be disposed adjacent to the second outer wall. The method further comprises the step of hingedly moving the second major end closure flap from the opened position thereof to the closed position thereof such that second major end closure flap overlies the first major and first minor end closure flaps and such that the first minor end closure flap is disposed between the first and second major end closure flaps.

According to a fourth aspect of the present disclosure there is provided a carton for packaging one or more articles comprising a tubular structure having a plurality of outer walls defining an interior volume for receiving one or more articles, the plurality of outer walls including first, second and third outer walls; and a plurality of end closure flaps for at least partially closing an open end of the tubular structure. The plurality of end closure flaps includes a first major, a second major and a first minor end closure flaps. The first major end closure flap is hinged to the first outer wall so as to be hingedly movable between an opened position, where the first major end closure flap lies generally in a plane of the first outer wall, and a closed position where the first major end closure flap at least partially closes the open end. The first minor end closure flap is hinged to the second outer wall so as to be hingedly movable between an opened position, where the first minor end closure flap lies generally in a plane of the second outer wall, and a closed position where the first minor end closure flap at least partially closes the open end, the second outer wall being disposed adjacent to the first outer wall. The second major end closure flap is hinged to the third outer wall so as to be hingedly movable between an opened position, where the second major end closure flap lies generally in a plane of the third outer wall, and a closed position where the third major end closure flap at least partially closes the open end. The first minor end closure flap is coupled to the first major end closure flap such that the first minor end closure flap moves from the opened position thereof towards the closed position thereof in response to movement of the first major end closure flap from the opened position thereof to the closed position thereof. The first minor end closure flap at least partially overlies the first major end closure flap when the first major end closure flap is in the closed position thereof. The first minor end closure flap partially overlies the first major end closure flap and the second major end closure flap overlies at least a portion of both the first major and first minor end closure flaps such that the second major end closure flap is secured directly to each of the first major and first minor end closure flaps.

Within the scope of this application it is envisaged and intended that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

Exemplary embodiments of the invention will now be described with reference to the accompanying drawings, in which:

FIG. 1 is a plan view from above of a blank for forming a carton according to a first embodiment;

FIG. 2 is a perspective view of a carton assembled from the blank of FIG. 1; and

FIGS. 3A to 4B are perspective views of stages of assembly of the carton of FIG. 2 from the blank of FIG. 1.

### DETAILED DESCRIPTION OF EMBODIMENTS

Detailed descriptions of specific embodiments of the package, blanks and cartons are disclosed herein. It will be understood that the disclosed embodiments are merely examples of the way in which certain aspects of the invention can be implemented and do not represent an exhaustive list of all of the ways the invention may be embodied. As used herein, the word “exemplary” is used expansively to refer to embodiments that serve as illustrations, specimens, models, or patterns. Indeed, it will be understood that the packages, blanks and cartons described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

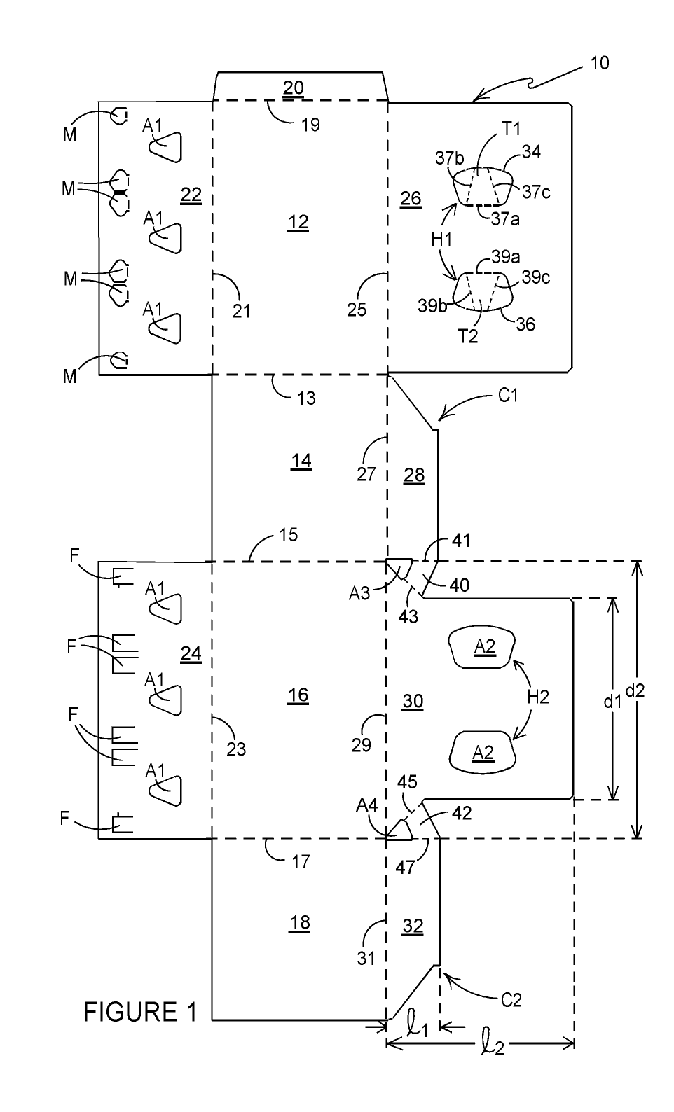

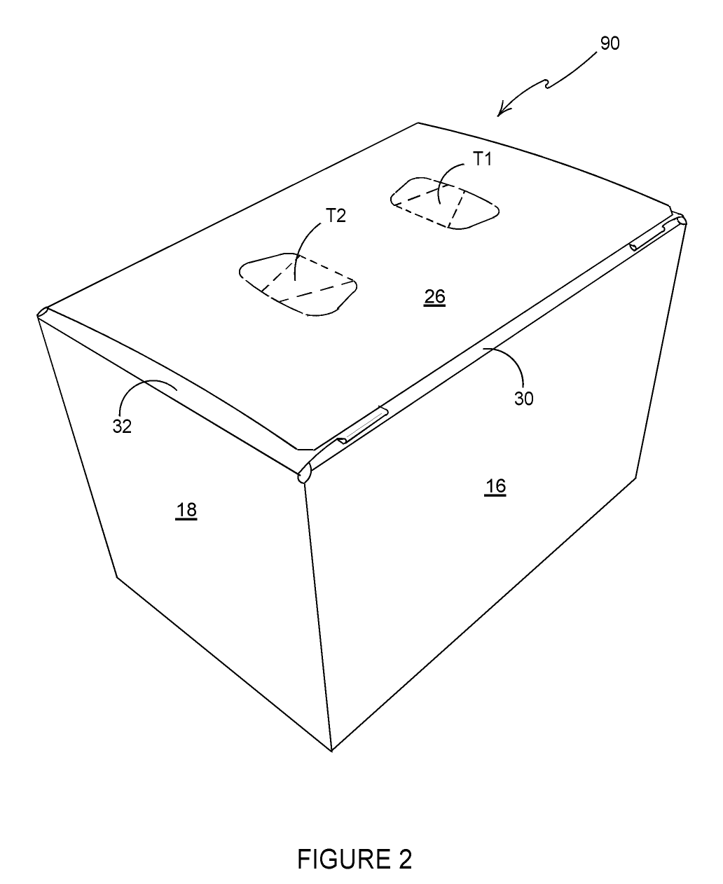

Referring to FIG. 1, there is shown a plan view of a blank 10 capable of forming a carton or carrier 90, as shown in FIG. 2, for containing and carrying a group of primary products such as, but not limited to, bottles or cans, hereinafter referred to as articles B. The blank 10 forms a secondary package for packaging at least one primary product container or package.

In the embodiments detailed herein, the terms “carton” and “carrier” refer, for the non-limiting purpose of illustrating the various features of the invention, to a container for engaging and carrying articles, such as primary product containers. It is contemplated that the teachings of the invention can be applied to various product containers, which may or may not be tapered and/or cylindrical. Exemplary containers include bottles (for example metallic, glass or plastics bottles), cans (for example aluminium cans), tins, pouches, packets and the like.

The blanks 10 are formed from a sheet of suitable substrate. It is to be understood that, as used herein, the term “suitable substrate” includes all manner of foldable sheet material such as paperboard, corrugated board, cardboard, plastic, combinations thereof, and the like. It should be recognized that one or other numbers of blanks may be employed, where suitable, for example, to provide the carrier structure described in more detail below.

In the illustrated embodiment, the blank 10 is configured to form a carton or carrier 90 for packaging an exemplary arrangement of exemplary articles B. In the illustrated embodiment, the arrangement is a 2×3 matrix or array; in the illustrated embodiment two rows of three articles are provided and the articles B are beverage cans. Alternatively, the blank 10 can be configured to form a carrier for packaging other types, number and size of articles and/or for packaging articles in a different arrangement or configuration.

Referring to FIG. 1, the blank 10 comprises a plurality of main panels 12, 14, 16, 18 for forming outer walls of a carton carrier 90 (see FIG. 2). The plurality of main panels 12, 14, 16, 18 includes a first side panel 12. The first side panel 12 is hinged to a first end panel 14 by a hinged connection such as a fold line 13. The first end panel 14 is hinged to a second side panel 16 by a hinged connection such as a fold line 15. The second side panel 16 is hinged to a second end panel 18 by a hinged connection such as a fold line 17. The first side panel 12 is hinged to a securing panel 20 by a hinged connection such as a fold line 19. The plurality of main panels 12, 14, 16, 18 define a tubular structure in a set up carton 90.

The blank 10 comprises at least one end closure panel for forming a base wall of the carton 90. Optionally, the blank 10 comprises a first base panel 22 hinged to the first side panel 12 by a hinged connection such as a fold line 21 and a second base panel 24 hinged to the second side panel 16 by a hinged connection such as a fold line 23.

Optionally, the first and second base panels 22, 24 comprise a plurality of first apertures A1 for facilitating assembly of the carton 90. The first apertures A1 may be substantially triangular in shape and may be engaged by a packaging device to facilitate alignment and tightening of both of the first and second base panels 22, 24 during the assembly process.

Optionally, the first and second base panels 22, 24 comprise a complementary locking mechanism. The first base panel 22 comprises a first part of the complementary locking mechanism. The first part comprises one or more male tabs M struck from the first base panel 22. The second base panel 24 comprises a second part of the complementary locking mechanism. The second part comprises one or more openings for receiving a respective one of said one or more male tabs M. The openings may be defined at least in part by a female tabs F struck from the second base panel 24. In alternative embodiments, the first and second base panels 22, 24 may be secured together by alternative securing means such as, but not limited to, glue or other adhesive treatment or mechanical apparatus such as staples. In still other embodiments a composite base panel may be formed from four base panels, each base panel being hinged to a respective one of the plurality of main panels 12, 14, 16, 18; the four base panels may be arranged to be self-erecting to close the lower end of the carton 90 when the carton is erected into a tubular form from a flat collapsed condition.

The blank 10 comprises a plurality of end closure panels 26, 28, 30, 32 for forming a composite top wall of the carton 90. The blank 10 comprises a first top panel 26 hinged to the first side panel 12 by a hinged connection such as a fold line 25, a second top panel 28 hinged to the first end panel 14 by a hinged connection such as a fold line 27, a third top panel 30 hinged to the second side panel 16 by a hinged connection such as a fold line 29, and a fourth top panel 32 hinged to the second end panel 18 by a hinged connection such as a fold line 31.

The second top panel 28 is hingedly connected to the third top panel 30 by a first web panel 40. The first web panel 40 is hingedly connected to the second top panel 28 by a first fold line 41 and is hingedly connected to the third top panel 30 by a second fold line 43. A first relief aperture A3 is defined in part by the first web panel 40, a portion of the second top panel 28 and a portion of the third top panel 30. Optionally, the first relief aperture A3 is substantially triangular in shape and a corner of the first relief aperture A3 may interrupt the intersection between the fold line 15 and fold lines 27, 29.

The third top panel 30 is hingedly connected to the fourth top panel 32 by a second web panel 42. The second web panel 42 is hingedly connected to the third top panel 30 by a third fold line 45 and is hingedly connected to the fourth top panel 32 by a fourth fold line 47. A second relief aperture A4 is defined in part by the second web panel 42, a portion of the fourth top panel 32 and a portion of the third top panel 30. Optionally, the second relief aperture A4 is substantially triangular in shape and a corner of the second relief aperture A4 may interrupt the intersection between the fold line 17 and fold lines 29, 31.

The second and fourth top panels 28, 32 form minor top panels (also referred to herein as first and second minor end closure flaps respectively) or dust flaps.

The first and third top panels 26, 30 form major top panels (also referred to herein as second and first major end closure flaps respectively) and together substantially close the first, upper, end of the tubular structure defined by the plurality of main panels 12, 14, 16, 18.

Optionally, the first and third top panels 26, 30 each comprise parts of a handle structure H1, H2 respectively. The first part of the handle structure H1 comprises a pair of first handle openings defined in the first top panel 26. Each of the first handle openings is defined at least in part by a cushioning flap T1, T2 respectively. A first cushioning flap T1 is hinged to the first top panel 26 by a hinged connection 37A in the form of a fold line. The first cushioning flap T1 is defined in part by a cut line or severance line 34. The first cushioning flap T1 may comprise a pair of optional fold lines 37B, 37C each extending between the fold line 37A and the severance line 34. A second cushioning flap T2 is hinged to the first top panel 26 by a hinged connection 39A in the form of a fold line. The second cushioning flap T2 is defined in part by a cut line or severance line 36. The second cushioning flap T2 may comprise a pair of optional fold lines 39B, 39C each extending between the fold line 39A and the severance line 36.

The second part of the handle structure H2 comprises a pair of second handle openings A2 defined in the third top panel 30. Each of the pair of second handle openings A2 is arranged to be in vertical registry with a respective one of the pair of first handle openings in the first top panel 26, when in a set up condition.

Each of the pair of second handle openings A2 is configured to receive a respective one of the first and second cushioning flaps T1, T2. When the handle structure is in use, at least one of the first and second cushioning flaps T1, T2 is folded out of the plane of the first top panel 26 and at least partially passed through the respective one of the pair of second handle openings A2 so as to extend through the third top panel 30.

Optionally, the second top panel 28 comprises a cutaway C1 proximate the first top panel 26 and distal from the third top panel 30. The cutaway C1 is configured to define a chamfered free edge opposing the hinged connection 27 between the second top panel 28 and the first end panel 14.

Optionally, the fourth top panel 32 comprises a cutaway C2 distal from the third top panel 30. The cutaway C2 is configured to define a chamfered free edge opposing the hinged connection 31 between the fourth top panel 32 and the second end panel 18.

The second side panel 16 has a width equal to a first width dimension d₂. The third top panel 30 comprises a first portion proximate the second side panel 16. The first portion is substantially the same width as the second side panel 16 proximate the fold line 29. The first portion is tapered so as to reduce the width from the first width dimension d₂ to a second width dimension d₁. The third top panel 30 comprises a second portion spaced apart from the second side panel 16 by the first portion. The second portion has a substantially uniform width equal to the second width dimension d₁. The reduced width of the second portion of the third top panel 30 may prevent, or at least reduce, the likelihood of the third top panel 30 fouling on the second and fourth top panels 28, 32, or in other words being inhibited from being folded, when the top end of the carton 90 is being closed during assembly.

Each of the first and second web panels 40, 42 may be hinged to the first portion of the third top panel 30 along first and second side edges thereof. The first and second side edges of the first portion may be convergently arranged with respect to each other. The first and second side edges of the first portion of the third top panel 30 are defined in part by the fold lines 43, 45 respectively.

The third top panel 30 comprises a first length dimension l₂ defined between the fold line 29 and an opposing free end edge of the third top panel 30.

The fourth top panel 28 comprises a second length dimension l₁ defined between the fold line 31 and an opposing free end edge of the fourth top panel 32. The second top panel 28 comprises a length dimension, defined between the fold line 27 and an opposing free end edge of the second top panel 28, equal second length dimension l₁.

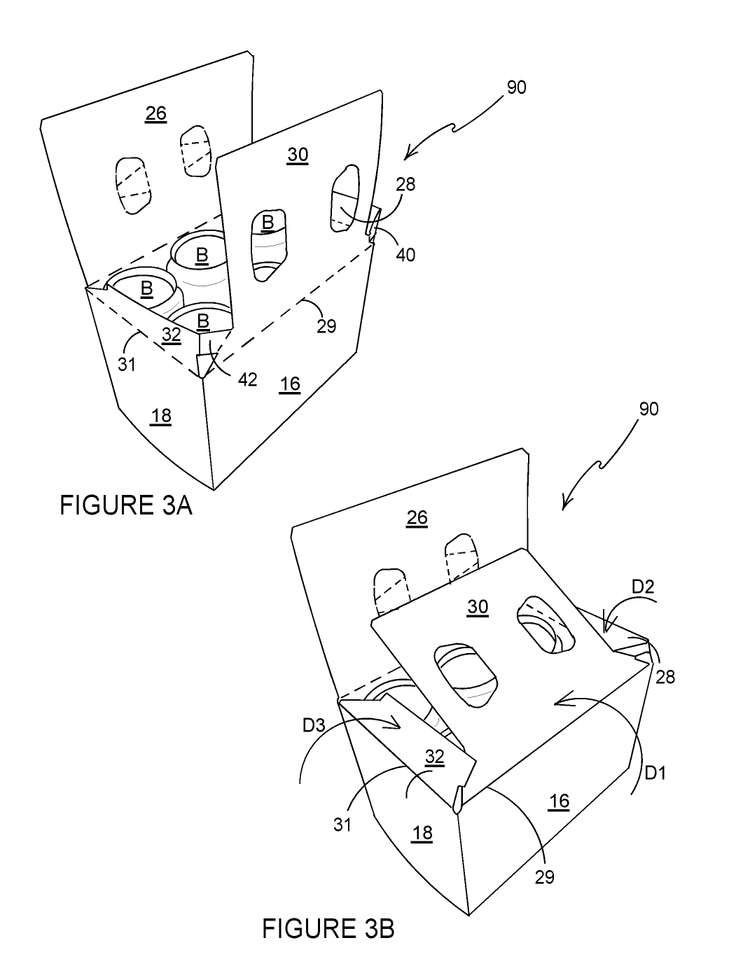

In this way the third top panel 30 extends proud of the second and fourth top panels 28, 32. Referring to FIG. 3A is can be seen that the third top panel 30 stands proud of the second and fourth top panels 28, 32, this facilitates mechanised assembly of the carton 90, for example the portion of the third top panel 30 which stands proud of the second and fourth top panels 28, 32 can be readily engaged by a packaging machine device such as, but not limited to, a static guide or other panel folding device.

Turning to the construction of the carrier 90 from the blank 10, the carrier 90 may be formed by a series of sequential folding operations in a straight line machine so that the carrier 90 may not be required to be inverted to complete its construction.

The blank 10 is folded about the fold line 13 so as to bring the first side panel 12 into face contacting relationship with the first end panel 14 and the second side panel 16; the securing panel 20 is brought into face contacting relationship with the second side panel 16.

Glue or other adhesive treatment is applied to an outer surface of the securing panel 20. In other embodiments glue or other adhesive treatment is applied to an inner surface of the second end panel 18.

The blank 10 is then folded about fold line 17 so as to bring the second end panel 18 into face contacting relationship with the securing panel 20. The second end panel 18 is secured to the securing panel 20.

In alternative embodiments the second end panel 18 may be secured to the securing panel 20 by alternative securing means for example, but not limited to, staples or other mechanical fixing means.

The blank 10 can be shipped or distributed in this form to a conversion plant where the blank 10 is erected about a group of articles B.

The flat collapsed carton may be erected into a tubular structure by separating the first side panel 12 from the second side panel 16. This may be achieved, for example, by unfolding the second end panel 18 about the fold line 17 with respect to the second side panel 16.

The carton 90, in its open-ended tubular form, may be loaded with articles B through one of the open ends. It will be appreciated that in other embodiments one of the open ends, for example a first or lower end, of the carton 90 may be closed before loading the carton 90 with articles B through the remaining open end.

Once the carton 90 is loaded with articles B the ends of the tubular structure are closed.

The first, lower, end of the tubular structure is closed by folding the first base panel 22 and the second base panel 24 about fold lines 21, 23 respectively.

The second base panel 24 is folded first; the first base panel 22 is then folded so as to at least partially overlap the second base panel 24.

In embodiments having a complementary locking mechanism, each of the male tabs M is aligned in vertical registry with a respective one of the female tabs F. The male tabs M are displaced out of the plane of the first base panel 22 inwardly of the carton 90. Each of the male tabs M interacts with one of the female tabs F displacing said one of the female tabs F out of the plane of the second base panel 24 inwardly of the carton 90, so as to create an opening in the second base panel 24. Each of the male tabs M passes through a respective opening in the second base panel 24. The male tabs M comprise shoulders for retaining the male tabs M within said openings. The male tabs M may deform or fold while passing through the openings and may at least partially unfold upon insertion into the carton 90.

A second, upper, end of the tubular structure is closed by folding the third top panel 30 (see FIG. 3B) about the fold line 29 as indicated by direction arrow Dl.

The second and fourth top panels 28, 32 are folded automatically about fold lines 27, 31 respectively in response to folding the third top panel 30.

The second and fourth top panels 28, 32 are folded so as to partially overlap with the third top panel 30. The second and fourth top panels 28, 32 are disposed over or above the third top panel 30. In this way the third top panel 30 is disposed innermost.

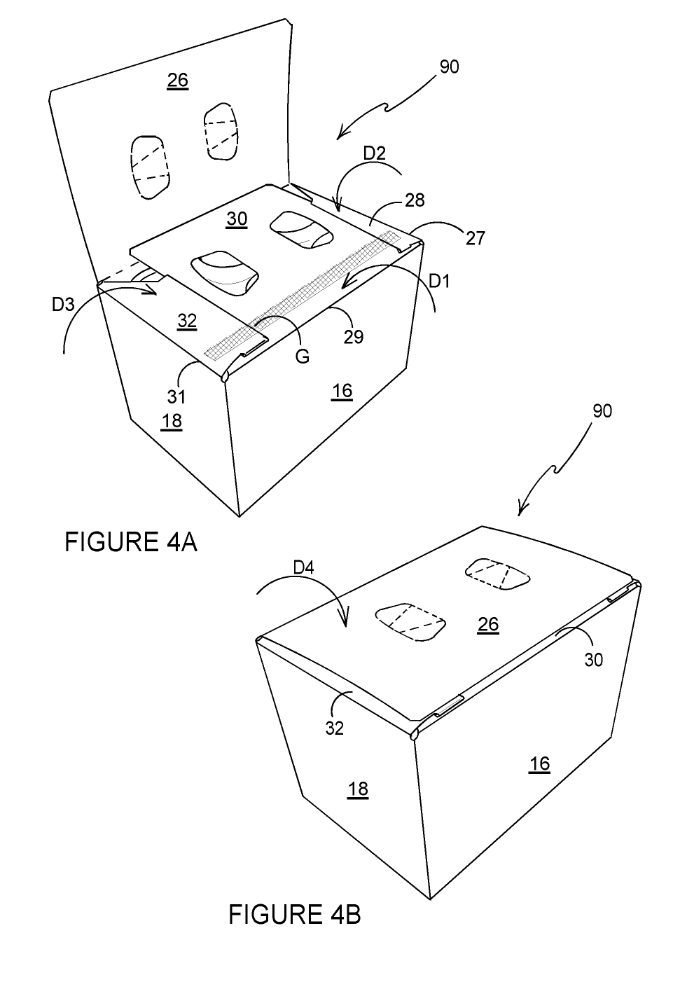

Glue G or other adhesive treatment may be applied to an outer surface of the second, third and fourth top panels 28, 30, 32 as shown in FIG. 4A.

The first top panel 26 can then be folded, as indicated by direction arrow D4 in FIG. 4B, about the fold line 25 to be brought into contact with the second, third and fourth top panels 28, 30, 32 and secured thereto.

Advantageously, there is no requirement to individually fold the second and fourth top end closure panels 28, 32. The second and fourth top end closure panels 28, 32 may be at least partially folded in response to folding the third top panel 30.

In some embodiments, the second and fourth top end closure panels 28, 32 are partially folded in response to folding the third top panel 30. Folding of the second and fourth top end closure panels 28, 32 may be completed by folding the first top panel 26 over the second and fourth top end closure panels 28, 32. In such embodiments, glue or other adhesive treatment may be applied to an inner surface of the first top panel 26.

The cutaways C1, C2 may facilitate construction of the carton 90, allowing the first top panel 26 to be folded to a greater extent before contacting the second and fourth top end closure panels 28, 32 than if the second and fourth top end closure panels 28, 32 comprised square corners in place of the cutaways C1, C2.

In other embodiments, the second and fourth top end closure panels 28, 32 are folded to be substantially perpendicular to the first or second end panel 14, 18 to which they are respectively hinged.

In some embodiments, one or more of the top panels 26, 28, 30, 32 may be pre-folded prior to assembly. For example, but not limited to, the third top panel 30 may be folded outwardly prior to being folded inwardly to close the top end of the carton 90.

In other embodiments, the fold lines 25, 27, 29, 31 may be configured such that pre-folding of the top panels 26, 28, 30, 32 is unnecessary. The fold lines 25, 27, 29, 31 may be readily folded and may be configured to offer weak or reduced resistance to folding. This may be achieved by use of perforations, short slits, half-cuts, partial-depth cuts or any combination of the aforesaid features.

The assembled carton 90 is shown in FIG. 2. The second and fourth top end closure panels 28, 32 are disposed between the first and third top end closure panels 26, 30.

The present disclosure teaches providing a tubular carton 90, an automatic or self-erecting end closure structure. More particularly, the carton 90 comprises a plurality of end closure panels which can be simultaneously or automatically folded. A first one of the plurality of end closure panels is coupled to at least one adjacently disposed end closure panel, such that the at least one adjacently disposed end closure panel is folded in response to folding the first one of the plurality of end closure panels. The at least one adjacently disposed end closure panel is folded into an at least partially overlying condition with the first one of the plurality of end closure panels. The carton may comprise a further end closure panel disposed in an overlying condition with both the first one of the plurality of end closure panels and the at least one adjacently disposed end closure panel. The further end closure panel may be dimensioned to substantially fully close the end of the tubular structure so as to substantially conceal both the first one of the plurality of end closure panels and the at least one adjacently disposed end closure panel therebelow. The present disclosure also teaches a method of assembling the tubular carton 90.

The present disclosure also teaches providing a carton for packaging one or more articles comprising, a tubular structure having a plurality of outer walls defining an interior volume for receiving one or more articles and a plurality of end closure flaps for at least partially closing an open end of the tubular structure. The plurality of outer walls including first and second outer walls and the plurality of end closure flaps including first major and first minor end closure flaps. The first major end closure flap is hinged to the first outer wall so as to be hingedly movable between an opened position where the first major end closure flap lies generally in a plane of the first outer wall and a closed position where the first major end closure flap at least partially closes the open end. The first minor end closure flap is hinged to the second outer wall so as to be hingedly movable between an opened position where the first minor end closure flap lies generally in a plane of the second outer wall and a closed position where the first minor end closure flap at least partially closes the open end, the second outer wall being disposed adjacent to the first outer wall. The first minor end closure flap is coupled to the first major end closure flap such that the first minor end closure flap moves from the opened position thereof toward the closed position thereof in response to movement of the first major end closure flap from the opened position thereof to the closed position thereof. The first minor end closure flap at least partially overlies the first major end closure flap when the first major end closure flap is in the closed position thereof. The first major end closure flap is greater in a length dimension than the first minor end closure flap, the length dimension of the first major and first minor end closure flaps being defined by the maximum distance between a free end of a respective one of the first major and first minor end closure flaps and a hinged connection between said respective one of the first major and first minor end closure flaps and the respective one of the plurality of outer walls to which said respective one of the first major and first minor end closure flaps is hinged such that a portion of the first major end closure flap extends proud of the first minor end closure flap when the first major and the first minor end closure flap are each in the opened position. The present disclosure also teaches providing a blank for forming aforesaid carton.

The present disclosure also teaches providing a carton with a plurality of end closure flaps for at least partially closing an open end of the tubular structure. The plurality of end closure flaps including a first major, a second major and a first minor end closure flaps. The first major end closure flap is hinged to the first outer wall so as to be hingedly movable between an opened position where the first major end closure flap lies generally in a plane of the first outer wall and a closed position where the first major end closure flap at least partially closes the open end. The first minor end closure flap is hinged to the second outer wall so as to be hingedly movable between an opened position where the first minor end closure flap lies generally in a plane of the second outer wall and a closed position where the first minor end closure flap at least partially closes the open end, the second outer wall being disposed adjacent to the first outer wall. The second major end closure flap is hinged to the third outer wall so as to be hingedly movable between an opened position where the second major end closure flap lies generally in a plane of the third outer wall and a closed position where the third major end closure flap at least partially closes the open end. The first minor end closure flap is coupled to the first major end closure flap such that the first minor end closure flap moves from the opened position thereof toward the closed position thereof in response to movement of the first major end closure flap from the opened position thereof to the closed position thereof. The first minor end closure flap at least partially overlies the first major end closure flap when the first major end closure flap is in the closed position thereof. The first minor end closure flap is arranged to partially overlie the first major end closure flap. The second major end closure flap is arranged to overlie at least a portion of both the first major and first minor end closure flaps such that the second major end closure flap can secured directly, for example using glue or other adhesive treatment, to each of the first major and first minor end closure flaps.

It will be recognized that as used herein, directional references such as “top”, “bottom”, “base”, “front”, “back”, “end”, “side”, “inner”, “outer”, “upper” and “lower” do not necessarily limit the respective panels to such orientation, but may merely serve to distinguish these panels from one another.

As used herein, the terms “hinged connection” and “fold line” refer to all manner of lines that define hinge features of the blank, facilitate folding portions of the blank with respect to one another, or otherwise indicate optimal panel folding locations for the blank. Any reference to “hinged connection” should not be construed as necessarily referring to a single fold line only; indeed a hinged connection can be formed from two or more fold lines wherein each of the two or more fold lines may be either straight/linear or curved/curvilinear in shape. When linear fold lines form a hinged connection, they may be disposed parallel with each other or be slightly angled with respect to each other. When curvilinear fold lines form a hinged connection, they may intersect each other to define a shaped panel within the area surrounded by the curvilinear fold lines. A typical example of such a hinged connection may comprise a pair of arched or arcuate fold lines intersecting at two points such that they define an elliptical panel therebetween. A hinged connection may be formed from one or more linear fold lines and one or more curvilinear fold lines. A typical example of such a hinged connection may comprise a combination of a linear fold line and an arched or arcuate fold line which intersect at two points such that they define a half moon-shaped panel therebetween.

As used herein, the term “fold line” may refer to one of the following: a scored line, an embossed line, a debossed line, a line of perforations, a line of short slits, a line of half-cuts, a single half-cut, an interrupted cut line, a line of aligned slits, a line of scores and any combination of the aforesaid options.

It should be understood that hinged connections and fold lines can each include elements that are formed in the substrate of the blank including perforations, a line of perforations, a line of short slits, a line of half-cuts, a single half-cut, a cut line, an interrupted cut line, slits, scores, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

The phrase “in registry with” as used herein refers to the alignment of two or more elements in an erected carton, such as an aperture formed in a first of two overlapping panels and a second aperture formed in a second of two overlapping panels. Those elements in registry with each other may be aligned with each other in the direction of the thickness of the overlapping panels. For example, when an aperture in a first panel is “in registry with” a second aperture in a second panel that is placed in an overlapping arrangement with the first panel, an edge of the aperture may extend along at least a portion of an edge of the second aperture and may be aligned, in the direction of the thickness of the first and second panels, with the second aperture.

As used herein, the terms “major end closure flap” and “minor end closure flap” each refers to all of end closure flaps that are connected to respective carton walls by hinged connections. In the present application, one or more major end closure flaps and one or more minor end closure flaps may together form an end closure wall which closes at least a part of an end of a tubular carton structure. In such an end closure wall, a major end closure flap and a minor end closure flap each may provide an innermost layer, an outermost layer or even an intermediate layer that is sandwiched between innermost and outermost layers. Further in the present application, a major end closure flap and a minor end closure flap each may be of a length dimension that is generally equal to, or less than, the distance between the mother carton wall to which the respective end closure flap is connected and another carton wall opposing the mother carton wall. The term “length dimension” as used herein refers to a dimension that is defined by the maximum distance between the free end of the respective end closure flap and the hinged connection between the respective end closure flap and its mother carton wall to which the respective end closure flaps is connected.

1. A carton for packaging one or more articles comprising:
a tubular structure having a plurality of outer walls defining an interior volume for receiving one or more articles, the plurality of outer walls including first and second outer walls; and
a plurality of end closure flaps for at least partially closing an open end of the tubular structure, the plurality of end closure flaps including first major and first minor end closure flaps,
wherein the first major end closure flap is hinged to the first outer wall so as to be hingedly movable between an opened position where the first major end closure flap lies generally in a plane of the first outer wall and a closed position where the first major end closure flap at least partially closes the open end,
wherein the first minor end closure flap is hinged to the second outer wall so as to be hingedly movable between an opened position where the first minor end closure flap lies generally in a plane of the second outer wall and a closed position where the first minor end closure flap at least partially closes the open end, the second outer wall being disposed adjacent to the first outer wall,
wherein the first minor end closure flap is coupled to the first major end closure flap such that the first minor end closure flap moves from the opened position thereof toward the closed position thereof in response to movement of the first major end closure flap from the opened position thereof to the closed position thereof,
wherein the first minor end closure flap at least partially overlies the first major end closure flap when the first major end closure flap is in the closed position thereof, and
wherein the first major end closure flap is greater in a length dimension than the first minor end closure flap, the length dimension of the first major and first minor end closure flaps being defined by the maximum distance between a free end of a respective one of the first major and first minor end closure flaps and a hinged connection between said respective one of the first major and first minor end closure flaps and the respective one of the plurality of outer walls to which said respective one of the first major and first minor end closure flaps is hinged such that a portion of the first major end closure flap extends proud of the first minor end closure flap when the first major and the first minor end closure flap are each in the opened position.

2. A carton according to claim 1 wherein the plurality of outer walls further includes a third outer wall, wherein the plurality of end closure flaps further includes a second major end closure flap hinged to the third outer wall so as to be hingedly movable between an opened position where the second major end closure flap lies generally in a plane of the third outer wall and a closed position where the second major end closure flap at least partially closes the open end, the third outer wall being disposed adjacent to the second outer wall, the second major end closure flap overlying the first major and first minor end closure flaps when the first major, first minor and second major end closure flaps are in the closed positions respectively, such that the first minor end closure flap is disposed between the first and second major end closure flaps.

3. A carton according to claim 2 wherein the plurality of outer walls further includes a fourth outer wall, wherein the plurality of end closure flaps further includes a second minor end closure flap hinged to the fourth outer wall so as to be hingedly movable between an opened position where the second minor end closure flap lies generally in a plane of the fourth outer wall and a closed position where the second minor end closure flap at least partially closes the open end, the fourth outer wall being disposed adjacent to the first and third outer walls, wherein the second minor end closure flap is coupled to the first major end closure flap such that the second minor end closure flap moves from the opened position thereof toward the closed position thereof in response to movement of the first major end closure flap from the opened position thereof to the closed position thereof, and wherein the second minor end closure flap at least partially overlies the first major end closure flap when the first major end closure flap is in the closed position thereof and wherein second major end closure flap overlies the second minor end closure flap when the second major and second minor end closure flaps are in the closed positions respectively, such that the second minor end closure flap is disposed between the first and second major end closure flaps.

4. A carton according to claim 1 wherein the first major end closure flap comprises a first portion proximate a hinged connection between the first major end closure flap and the first outer wall and a second portion distal from the hinged connection, wherein the first portion comprises a first width dimension and the second portion comprises a second width dimension, the first width dimension being substantially equal to a width dimension of the first outer wall, and wherein the second width dimension is less than the width dimension of the first outer wall.

5. A carton according to claim 1 wherein the first minor end closure flap is coupled to the first major end closure flap by a first web panel.

6. A carton according to claim 3 wherein the second minor end closure flap is coupled to the first major end closure flap by a second web panel.

7. A carton according to claim 5 wherein a first web panel is hingedly connected to the first minor end closure flap and is hingedly connected to a first portion of the first major end closure flap, the first portion being proximate a hinged connection between the first major end closure flap and the first outer wall.

8. A carton according to claim 6 wherein second web panel is hingedly connected to the second minor end closure flap and is hingedly connected to a first portion of the first major end closure flap, the first portion being proximate a hinged connection between the first major end closure flap and the first outer wall.

9. A carton according to claim 5 wherein the first minor end closure flap comprises a first cutaway defining a chamfered edge thereof, and wherein the first cutaway is provided at a first end of the first minor end closure flap, the first end opposing a second end of the first minor end closure flap to which the first web panel is hinged.

10. A carton according to claim 6 wherein the second minor end closure flap comprises a second cutaway defining a chamfered edge thereof, and wherein the second cutaway is provided at a first end of the second minor end closure flap, the first end opposing a second end of the second minor end closure flap to which the second web panel is hinged.

11. A blank for forming a carton, the blank comprising:
a plurality of panels for providing outer walls of a tubular structure, the plurality of panels including first and second panels; and
a plurality of end closure flaps for at least partially closing an open end of the tubular structure, the plurality of end closure flaps including first major and first minor end closure flaps,
wherein the first major end closure flap is hinged to the first panel such that when the tubular structure is set up, the first major end closure flap is hingedly movable between an opened position where the first major end closure flap lies generally in a plane of the first panel and a closed position where the first major end closure flap at least partially closes the open end,
wherein the first minor end closure flap is hinged to the second panel such that when the tubular structure is set up, the first minor end closure flap is hingedly movable between an opened position where the first minor end closure flap lies generally in a plane of the second panel and a closed position where the first minor end closure flap at least partially closes the open end, the second panel being disposed adjacent to the first panel,
wherein the first minor end closure flap is coupled to the first major end closure flap such that the first minor end closure flap moves from the opened position thereof toward the closed position thereof in response to movement of the first major end closure flap from the opened position thereof to the closed position thereof,
wherein the first minor end closure flap at least partially overlies the first major end closure flap when the first major end closure flap is in the closed position, and
wherein the first major end closure flap comprises a first length dimension, the first length dimension being defined by the maximum distance between a free end of the first major end closure flap and a hinged connection between the first major end closure flap and the first panel and wherein the first minor end closure flap comprises a second length dimension, the second length dimension being defined by the maximum distance between a free end of the first minor end closure flap and a hinged connection between the first minor end closure flap and the second panel,
the first length dimension being greater than the second length dimension such that a portion of the first major end closure flap extends proud from the first minor end closure flap.

12. A method of forming a carton, the carton comprising:
a tubular structure having a plurality of outer walls defining an interior volume for receiving one or more articles, the plurality of outer walls including first and second outer walls; and
a plurality of end closure flaps for at least partially closing an open end of the tubular structure, the plurality of end closure flaps including first major and first minor end closure flaps,
wherein the first major end closure flap is hinged to the first outer wall so as to be hingedly movable between an opened position where the first major end closure flap lies generally in a plane of the first outer wall and a closed position where the first major end closure flap at least partially closes the open end,
wherein the first minor end closure flap is hinged to the second outer wall so as to be hingedly movable between an opened position where the first minor end closure flap lies generally in a plane of the second outer wall and a closed position where the first minor end closure flap at least partially closes the open end, the second outer wall being disposed adjacent to the first outer wall,
wherein the first minor end closure flap is coupled to the first major end closure flap,
and wherein the first major end closure flap comprises a first length dimension, the first length dimension being defined by the maximum distance between a free end of the first major end closure flap and a hinged connection between the first major end closure flap and the first panel and wherein the first minor end closure flap comprises a second length dimension, the second length dimension being defined by the maximum distance between a free end of the first minor end closure flap and a hinged connection between the first minor end closure flap and the second panel,
the first length dimension being greater than the second length dimension such that a portion of the first major end closure flap extends proud from the first minor end closure flap,
the method comprising the steps of:
engaging the portion of the first major end closure flap that extends proud from the first minor end closure flap,
moving the first major end closure flap from the opened position thereof toward the closed position thereof;
automatically moving the first minor end closure flap from the opened position thereof toward the closed position thereof in response to the moving step of the first major end closure flap such that the first minor end closure flap at least partially overlies the first major end closure flap when the first major end closure flap is moved to the closed position thereof.

13. A method according to claim 12, wherein the plurality of outer walls further includes a third outer wall, wherein the plurality of end closure flaps further includes a second major end closure flap hinged to the third outer wall so as to be hingedly movable between an opened position where the second major end closure flap lies generally in a plane of the third outer wall and a closed position where the second major end closure flap at least partially closes the open end, the third outer wall being disposed adjacent to the second outer wall, the method further comprising the step of hingedly moving the second major end closure flap from the opened position thereof to the closed position thereof such that second major end closure flap overlies the first major and first minor end closure flaps and such that the first minor end closure flap is disposed between the first and second major end closure flaps.

14. A carton for packaging one or more articles comprising:
a tubular structure having a plurality of outer walls defining an interior volume for receiving one or more articles, the plurality of outer walls including first, second and third outer walls; and
a plurality of end closure flaps for at least partially closing an open end of the tubular structure, the plurality of end closure flaps including a first major, a second major and a first minor end closure flaps,
wherein the first major end closure flap is hinged to the first outer wall so as to be hingedly movable between an opened position where the first major end closure flap lies generally in a plane of the first outer wall and a closed position where the first major end closure flap at least partially closes the open end,
wherein the first minor end closure flap is hinged to the second outer wall so as to be hingedly movable between an opened position where the first minor end closure flap lies generally in a plane of the second outer wall and a closed position where the first minor end closure flap at least partially closes the open end, the second outer wall being disposed adjacent to the first outer wall,
wherein the second major end closure flap is hinged to the third outer wall so as to be hingedly movable between an opened position where the second major end closure flap lies generally in a plane of the third outer wall and a closed position where the third major end closure flap at least partially closes the open end,
wherein the first minor end closure flap is coupled to the first major end closure flap such that the first minor end closure flap moves from the opened position thereof toward the closed position thereof in response to movement of the first major end closure flap from the opened position thereof to the closed position thereof,
wherein the first minor end closure flap at least partially overlies the first major end closure flap when the first major end closure flap is in the closed position thereof,
and wherein the first minor end closure flap partially overlies the first major end closure flap and the second major end closure flap overlies at least a portion of both the first major and first minor end closure flaps such that the second major end closure flap is secured directly to each of the first major and first minor end closure flaps.
